(19) United States
(12) Patent Application Publication
(10) Pub. No.: US 2018/0301036 A1
(43) Pub. Date: Oct. 18, 2018

(54) ASSISTED TRAFFIC MERGE

(71) Applicant: Continental Automotive Systems, Inc., Auburn Hills, MI (US)

(72) Inventors: Luis Felipe Villavicencio, Tlaquepaque (MX); Maura Jazmin Alcala Segura, Tlaquepaque (MX); Jose Uriel Uribe Rivera, Guadalajara (MX)

(73) Assignee: Continental Automotive Systems, Inc., Auburn Hills, MI (US)

(21) Appl. No.: 16/010,042

(22) Filed: Jun. 15, 2018

Related U.S. Application Data
(63) Continuation of application No. PCT/US2016/065081, filed on Dec. 6, 2016.
(60) Provisional application No. 62/268,778, filed on Dec. 17, 2015.

(51) Int. Cl. G08G 1/16; G08G 1/0967

(52) U.S. Cl. CPC G08G 1/167; B60R 1/1207; G08G 1/0967

(57) ABSTRACT

A safety system and method of providing an assisted traffic merge feature for a vehicle includes determining, with an ECU, that the vehicle is approaching a merging situation based on a first plurality of vehicle sensors. A predicted merging location is determined by the ECU based on a second plurality of vehicle sensors. An area proximate to the vehicle is monitored with at least one sensor to detect the presence of any traffic. The ECU determines if traffic will be in the merging lane when the vehicle reaches the merging location and provides a merge recommendation based upon the predicted location of traffic when the vehicle reaches the merging location.

### CROSS REFERENCE TO RELATED APPLICATION

This application is a continuation of International application No. PCT/US2016/065081, filed Dec. 6, 2016, which claims the benefit of U.S. provisional patent application No. 62/268,778, filed Dec. 17, 2015, each of which is hereby incorporated by reference.

### TECHNICAL FIELD

The present disclosure relates to automotive vehicles, and more particularly to safety systems for automotive vehicles.

### BACKGROUND

An automotive vehicle may include sensor arrays and cameras mounted to the vehicle to detect objects in the area proximate to the vehicle for various safety systems for the vehicle and the driver. The various safety systems utilize the data to provide warnings to the driver and to initiate safety vehicle responses to minimize and/or avoid collisions. Once such system may include sensors or cameras for monitoring a vehicle blind spot or for replacing side mirrors of the vehicle with camera for viewing the area.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

According to one exemplary embodiment, a method of providing an assisted traffic merge feature for a vehicle includes determining with an electronic control unit that the vehicle is approaching a merging situation based on a first plurality of vehicle sensors. The method also includes determining with the electronic control unit a predicted merging location based on a second plurality of vehicle sensors. The method further includes monitoring an area proximate to the vehicle with at least one sensor to detect the presence of any traffic. The method also includes determining with the electronic control unit if traffic will be in the merging lane when the vehicle reaches the merging location. The method moreover includes providing a merge recommendation based upon the predicted location of traffic when the vehicle reaches the merging location.

According to one exemplary embodiment, a safety system for a vehicle having an assisted traffic merge feature includes a first plurality of sensors to monitor the vehicle and an area proximate to the vehicle. The safety system also includes a second plurality of sensors to monitor the vehicle and another area proximate to the vehicle. An electronic control unit is connected to the first and second plurality of sensors. The electronic control unit is configured with instructions for determining that the vehicle is approaching a merging situation based on the first plurality of vehicle sensors, determining a predicted merging location based on the second plurality of vehicle sensors, and monitoring the another area proximate to the vehicle with at least one sensor to detect the presence of any traffic. The electronic control unit is also configured with instructions for determining whether traffic will be in the merging lane when the vehicle reaches the merging location and providing a merge recommendation based upon the predicted location of traffic when the vehicle reaches the merging location.

### BRIEF DESCRIPTION OF THE DRAWINGS

The present disclosure will become more fully understood from the detailed description and the accompanying drawings, wherein:

FIG. 1 is a schematic view of a vehicle having a safety system with an assisted traffic merge feature according to an exemplary embodiment;

FIG. 2 is a perspective view of a wing mirror of the vehicle according to one embodiment showing positive feedback for the assisted traffic merge feature; and

FIG. 3 is a perspective view of the wing mirror according to one embodiment showing negative feedback for the assisted traffic merge feature.

### DETAILED DESCRIPTION

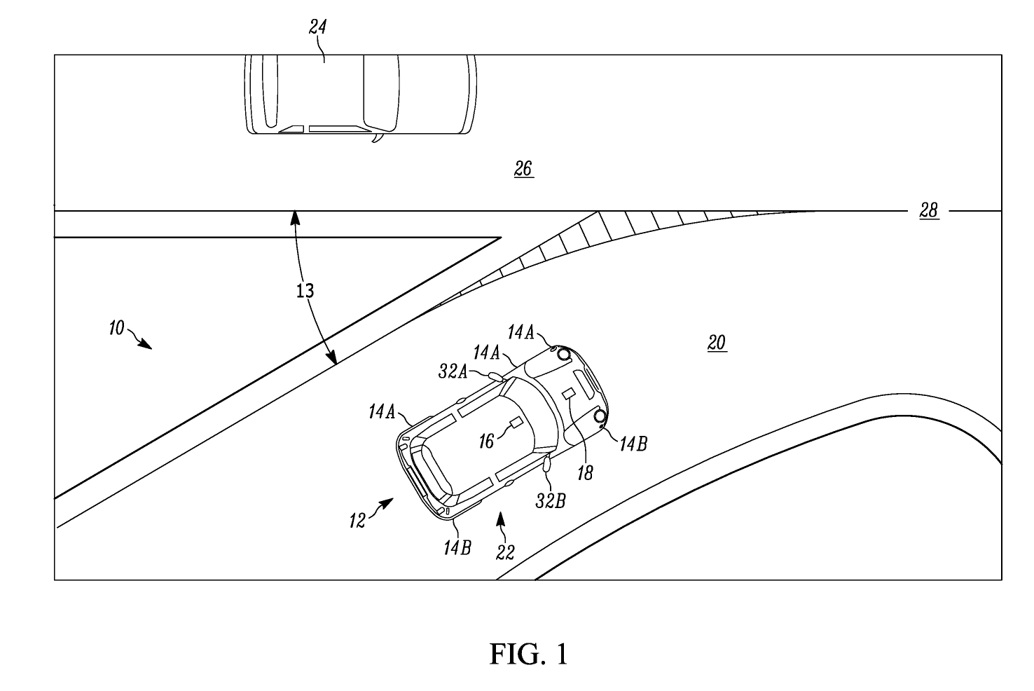

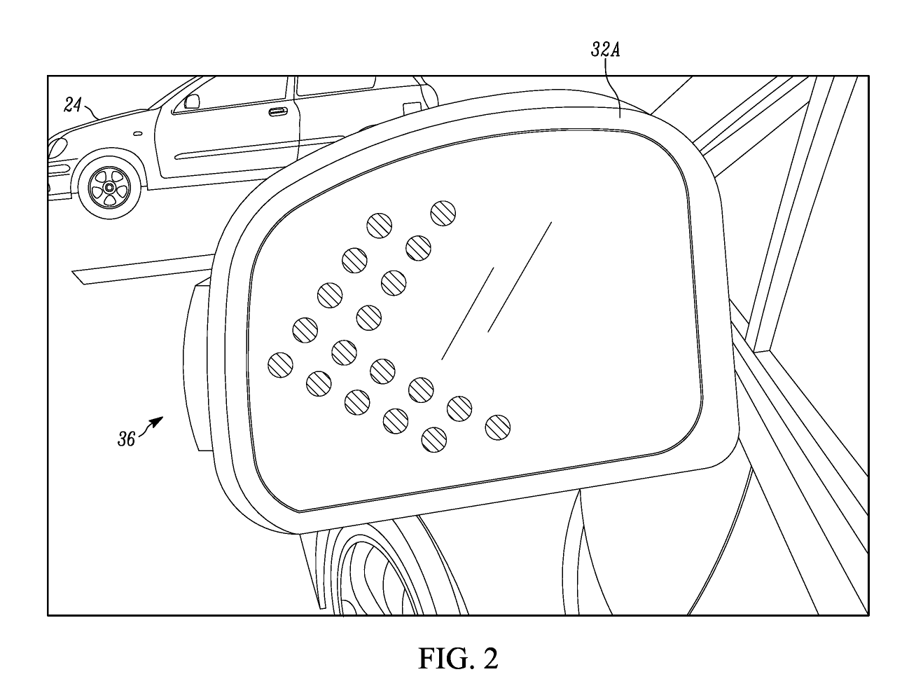

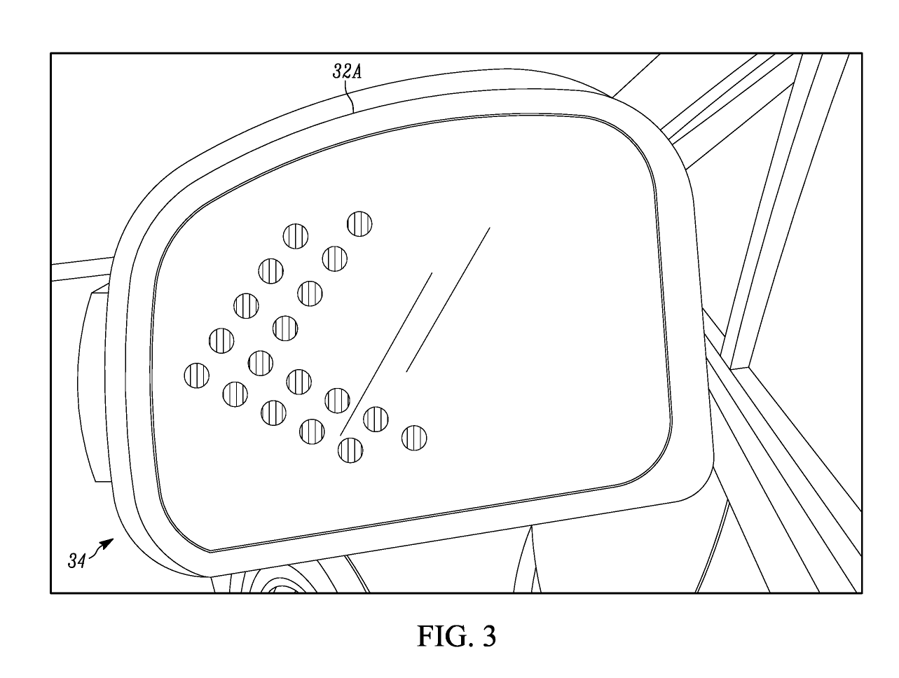

The following description is merely exemplary in nature and is in no way intended to limit the disclosure, its application, or uses. For purposes of clarity, the same reference numbers will be used in the drawings to identify similar elements. FIGS. 1-3 are schematic illustrations of a vehicle 10 having a safety systems 12 with an assisted traffic merge feature. The safety system preferably incorporates other existing vehicle 10 systems and may utilize the same sensors and components, as described below. The safety system 12 provides assistance to a vehicle driver when merging the vehicle 10 into another lane of traffic. In particular, for merging the vehicle 10 onto a highway from an entrance ramp where there may be a diminishing gap 13 between the ramp and the traffic lane. The assisted traffic merge feature of the safety system 12 needs to accommodate for any gap 13 between the current lane and current vehicle location, to the gap (or lack thereof) at the vehicle merge location in order to anticipate whether traffic in the merging lane will intersect with the vehicle 10 at the vehicle merge location.

The safety system 12 may be connected to other systems for the vehicle 10, including a blind spot monitoring system 13. The safety system 12 utilizes sensors/cameras 14 located at various points around the vehicle 10. The safety system 12 of the exemplary embodiment has at least one sensor/camera 14A, 14B which each detects an area on opposing sides of the vehicle 10. The sensor/camera 14A, 14B may be used for another vehicle system, such as blind spot monitoring, side view monitoring, etc. Other cameras 16 may also be positioned to capture the vehicle 10, such as forward or rear looking sensors/camera 16. The sensors/cameras 14 may be radar, lidar, ladar, bifocal, etc., and able to detect objects within a predetermined range (not labeled) and the distance of such objects to the vehicle 10. Additionally, the sensor/camera 14A, 14B may be able to determine the relative speed between the detected objects and the vehicle 10.

The safety system 12 utilizes an electronic control unit (“ECU”) 18. The ECU 18 may be a separate ECU 18 to provide control for the assisted traffic merge or may also be used by another vehicle system, such as the blind spot system 13. The ECU 18 receives input from the various sensors 14. The sensors 14 and camera(s) 16 may be located separately or together at various locations. One skilled in the art would be able to determine which sensors and cameras and the locations of the sensors and cameras that may provide useful information to the safety system 12., e.g., wheel speed sensors, steering wheel angle sensors, turn indicators, etc.

The vehicle 10 is in a current lane 20 at a current vehicle location 22. The safety system 12 uses the sensor 14 information reported to the ECU 18 to anticipate whether traffic 24 in a merging lane 26 will intersect with the vehicle 10 at a vehicle merge location 28.

Merging onto the highway is a stressful scenario for drivers because highway conditions (and other drivers) are unpredictable. When a driver in the vehicle 10 gets to a place where he intends to merge onto the traffic 24, i.e, the vehicle merge location 28, the system 12 in the vehicle 10 detects the driver intention, e.g., from an indicator light 30 being turned on and/or detecting the driver head position watching the wing mirror 32A, 32B, sometimes referred to as a side-view mirror. At this point the ECU 18 would run an algorithm based on the data/images from the sensor/camera 14A, 14B to detect if traffic 24 is approaching or if there is enough space to merge into the merging lane 26. Using LEDs in the wing mirrors 32A, 32B, which some cars are already equipped with, a visual feedback would be provided to the driver when merging is possible, such as turning the lights on with green color 34 when merge is recommended and turning them in red color when such merge is not recommended 36.

FIGS. 1-4 illustrate the vehicle 10 trying to merge traffic 24. As a direct consequence the driver turns on the corresponding indicator light 30 and turns to watch the wing mirror 32A, 32B, which is detected by the car software and cameras 14A, 14B. Based on measures from the sensors/camera 14A, 14B, the system 12 detects whether it is recommendable to merge, 34 or not to merge 36 into the traffic 24. The wing mirror 32A, 32B displays a visual feedback when it is possible or recommendable to merge into traffic, by using the led on the wing mirrors 32A, 32B. Alternatively, instead of a visual feedback, a tone from the radio or other device may be played when the merge is recommended.

The ECU 18 determines if any traffic 24 is present, and if so, the relative speed between the vehicle 10 and the traffic 24. Using information available including wheel speed sensors, steering wheel angle sensors to help identified the planned merging location 28, camera or sensors which can determine where the currently lane 20 and the merging lane 26 are and when the current lane 20 and the merging lane 26 will meet (i.e. gap 13 is zero), etc. the ECU 18 predicts when the vehicle 10 will reach a merging location 28 and if traffic 24 will be in the merging lane 26 at the merging location when the vehicle 10 reaches the merging location 28.

The sensors 14A, 14B and cameras 16 must monitor an area proximate to the vehicle 10 and the merging location 18. Although, sensors which are used for blind spot monitoring may also be used for the assisted traffic merge 12 the monitoring area for the assisted traffic merge is not limited to the vehicle blind spot and activation of the merge recommendation 34, 36 is independent of activation of a blind spot warning. The monitored area must include locations ahead of the vehicle 10 for slow moving traffic 24 relative to the vehicle 10 speed and behind the vehicle 10 for quickly moving traffic 24 relative to the vehicle speed. Additionally, the monitored area must extend far enough from the lateral location of the vehicle 10 to accommodate for the gap 13 and sense traffic 24 in the merging lane 26 ahead of reaching the merging location. By determining the merge recommendation prior to the vehicle 10 reaching the merge location 28 the driver is given time to adjust, e.g. vehicle speed, to obtain a positive merge recommendation 34 when they reach the merging location 28.

While the best modes for carrying out the invention have been described in detail the true scope of the disclosure should not be so limited, since those familiar with the art to which this invention relates will recognize various alternative designs and embodiments for practicing the invention within the scope of the appended claims.

What is claimed is:

1. A method of providing an assisted traffic merge feature for a vehicle comprising:
determining with an electronic control unit that the vehicle is approaching a merging situation based on a first plurality of vehicle sensors;
determining with the electronic control unit a predicted merging location based on a second plurality of vehicle sensors;
monitoring an area proximate to the vehicle with at least one sensor to detect the presence of any traffic;
determining with the electronic control unit if traffic will be in the merging lane when the vehicle reaches the merging location; and
providing a merge recommendation based upon the predicted location of traffic when the vehicle reaches the merging location.

2. The method of claim 1, wherein the merge recommendation is a positive recommendation if there is not traffic in the merging lane at the merging location and the merge recommendation is a negative recommendation if there is traffic in the merging lane at the merging location.

3. The method of claim 2, wherein the positive merge recommendation is a green light visible to the driver or a side of the vehicle adjacent the merging lane, and the negative merge recommendation is a red light visible to the driver or a side of the vehicle adjacent the merging lane.

4. The method of claim 2, wherein the positive and negative merge recommendation are different audio tones.

5. The method of claim 1, further comprising until the merging situation is completed repeating the steps of:
determining with the electronic control unit a predicted merging location based on a second plurality of vehicle sensors;
monitoring an area proximate to the vehicle with at least one sensor to detect the presence of any traffic;
determining with the electronic control unit if traffic will be in the merging lane when the vehicle reaches the merging location; and
providing a merge recommendation based upon the predicted location of traffic when the vehicle reaches the merging location.

6. The method of claim 1, wherein the first plurality of sensors include at least one of: steering wheel angle sensor, wheel speed sensor, turn indicator, forward looking camera, forward looking radar, forward looking lidar, and forward looking ladar.

7. The method of claim 1, wherein the second plurality of sensors include at least one of: steering wheel angle sensor, wheel speed sensor, forward looking camera, forward looking radar, forward looking lidar, forward looking ladar, side view camera, side view radar, side view lidar, side view ladar, blind spot monitor sensors.

8. The method of claim 1, wherein the first plurality of sensors and the second plurality of sensors are different from one another.

9. The method of claim 1, wherein determining with the electronic control unit if traffic will be in the merging lane when the vehicle reaches the merging location further comprises determining a relative speed of traffic to the vehicle.

10. A safety system for a vehicle having an assisted traffic merge feature, the system comprising:
a first plurality of sensors to monitor the vehicle and an area proximate to the vehicle;
a second plurality of sensors to monitor the vehicle and another area proximate to the vehicle;
an electronic control unit connected to the first and second plurality of sensors, wherein the electronic control unit is configured with instructions for;
determining that the vehicle is approaching a merging situation based on the first plurality of vehicle sensors;
determining a predicted merging location based on the second plurality of vehicle sensors;
monitoring the another area proximate to the vehicle with at least one sensor to detect the presence of any traffic;
determining whether traffic will be in the merging lane when the vehicle reaches the merging location; and
providing a merge recommendation based upon the predicted location of traffic when the vehicle reaches the merging location.

11. The safety system of claim 10, wherein the merge recommendation is a positive recommendation when there is not traffic predicted to be in the merging lane at the merging location and the merge recommendation is a negative recommendation when there is traffic in the merging lane at the merging location.

12. The safety system of claim 11, wherein the positive merge recommendation is a green light visible to the driver or a side of the vehicle adjacent the merging lane, and the negative merge recommendation is a red light visible to the driver or a side of the vehicle adjacent the merging lane.

13. The safety system of claim 11, wherein the positive and negative merge recommendation are different audio tones.

14. The safety system of claim 10, wherein the electronic control unit is further configured with instructions for, until the merging situation is completed, repeating the steps of:
determining with the electronic control unit a predicted merging location based on a second plurality of vehicle sensors;
monitoring an area proximate to the vehicle with at least one sensor to detect the presence of any traffic;
determining with the electronic control unit if traffic will be in the merging lane when the vehicle reaches the merging location; and
providing a merge recommendation based upon the predicted location of traffic when the vehicle reaches the merging location.

15. The safety system of claim 10, wherein the first plurality of sensors include at least one of: steering wheel angle sensor, wheel speed sensor, turn indicator, forward looking camera, forward looking radar, forward looking lidar, and forward looking ladar.

15. The safety system of claim 10, the second plurality of sensors include at least one of: steering wheel angle sensor, wheel speed sensor, forward looking camera, forward looking radar, forward looking lidar, forward looking ladar, side view camera, side view radar, side view lidar, side view ladar, blind spot monitor sensors.

16. The safety system of claim 10, wherein the first plurality of sensors and the second plurality of sensors are different from one another.

17. The safety system of claim 10, wherein determining with the electronic control unit if traffic will be in the merging lane when the vehicle reaches the merging location further comprises determining a relative speed of traffic to the vehicle.
